(19) United States
(12) Patent Application Publication
(10) Pub. No.: US 2020/0396601 A1
(43) Pub. Date: Dec. 17, 2020

(54) SUBSCRIBER STORAGE DOMAIN

(71) Applicant: AT&T Mobility II LLC, Atlanta, GA (US)

(72) Inventor: Arturo Maria, Bellevue, WA (US)

(21) Appl. No.: 16/443,522

(22) Filed: Jun. 17, 2019

(51) Int. Cl. H04W 12/00; H04W 88/18; H04L 29/08; H04W 8/18

(52) U.S. Cl. CPC H04W 12/002; H04W 12/0013; H04W 88/18; H04W 12/004; H04L 67/28; H04W 8/18; H04W 12/00514

(57) ABSTRACT

Storage for mobile devices are managed by service provider network elements. Storage may reside in the carrier core transparently as if it were residing on the mobile device. An imbedded agent may be added the mobile device, control plane network elements may be added to the carrier evolved packet core, and user plane network elements may be added to an enterprise network or edge network.

### TECHNICAL FIELD

The technical field generally relates to network storage and, more specifically, to systems and methods for subscriber storage in a network.

### BACKGROUND

Conventionally, mobile devices have storage located on the device or have access to storage in a remote data center based on use of a mobile application. There is a need for a means of accessing storage not located on a mobile device.

### SUMMARY

Conventional storage capabilities may allow a mobile device to access remote data center storage via a mobile application. However, the storage devices are not imbedded within the carrier space or they are not seamless or transparent to the mobile device. The disclosed subject matter provides ways for a subscriber mobile device of a wide area wireless network to access storage as if it was locally on the device.

Storage for mobile devices may be managed by service provider network elements. In order to manage the disclosed subscriber storage domain, an imbedded agent may be added the mobile device, control plane network elements may be added to the carrier EPC core, or user plane network elements may be added to an enterprise network or edge network.

In an example, an apparatus may include a processor and a memory coupled with the processor that effectuates operations. The operations may include obtaining a first request, the first request comprising a storage request associated with a mobile device; based on the first request, sending a second request to an access database; and responsive to sending the second request, obtaining information associated with the mobile device, wherein the information comprises an indication of a shared storage domain for the mobile device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system that may implement a subscriber storage domain.

FIG. 2 illustrates an exemplary message flow for a subscriber storage domain system.

FIG. 3 illustrates a schematic of an exemplary network device.

FIG. 4 illustrates an exemplary communication system that provides wireless telecommunication services over wireless communication networks.

FIG. 5 illustrates an exemplary telecommunications system in which the disclosed methods and processes may be implemented.

### DETAILED DESCRIPTION

The need to access large storage databases is increasing exponentially. Carriers have been disintermediated from this market where they play little to no role in the access of storage residing outside of the subscriber mobile device and have been excluded from the subscriber storage market. Conventionally, cloud storage providers may fill a significant segment of storage demand, but this type of cloud access requires the data to traverse outside of the carrier network or, in 5G, outside of the enterprise. The disclosed subject matter provides ways for subscriber mobile devices (e.g., mobile phones, IoT devices, tablets, or autonomous vehicles) to access network storage as if it was locally on the mobile device.

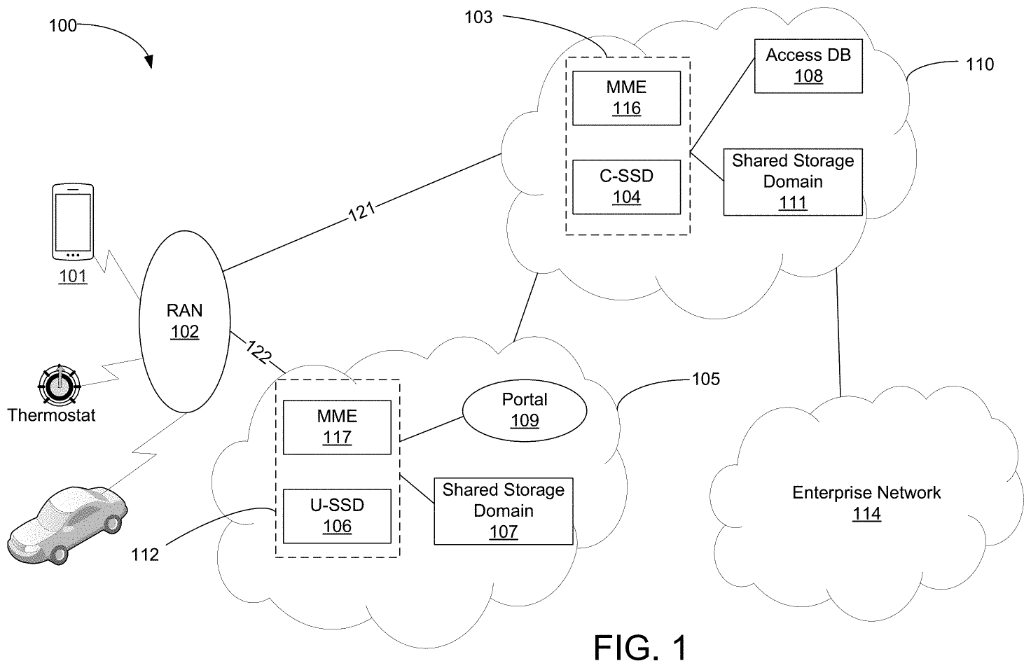

FIG. 1 illustrates an exemplary system that may implement a subscriber storage domain, as disclosed herein. System 100 includes mobile device 101 which may be communicatively connected with radio access network (RAN) 102 (e.g., 5G RAN or 5G distributed antenna system). Mobile device 101 may include an agent (e.g., microcode, firmware, virtual network function agent, application, or the like) that may assist with accessing a subscriber storage domain, as disclosed herein. The agent may be imbedded in a manner that assists in management of network storage across all or a selected subset of applications located on mobile device 101. RAN 102 may be communicatively connected with control plane network elements 103 of an evolved packet core (EPC), which may include mobility management entity (MME) 116, policy and charging rules function (PCRF) (not shown), serving gateway (SGW) (not shown), packet gateway (PGW) (not shown), or control plane subscriber storage domain (SSD) network element 104 (also referred herein as C-SSD 104), among other things. Control plane network elements 103 may be for a 5G network, which may implement control plane and user plane separation (CUPS).

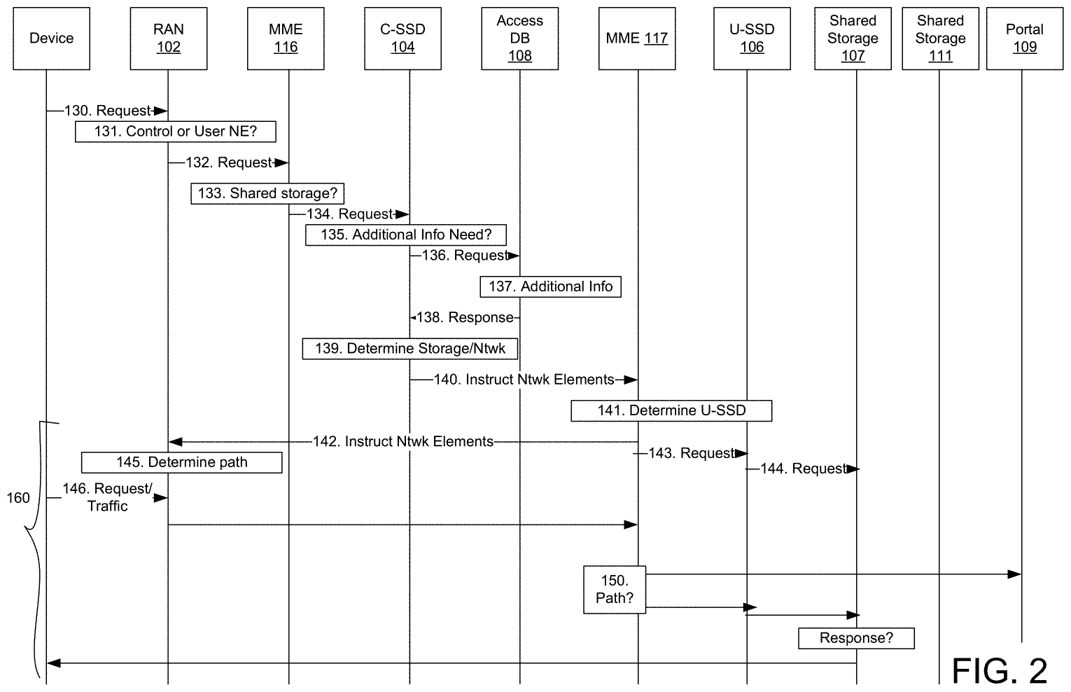

With continued reference to FIG. 2, C-SSD 104 may be connected with access database 108, shared storage domain 111 (also referred herein as a subscriber storage domain), enterprise network 112. Shared storage domain 111 may be flexible (on-demand and cloud-connected) storage within a network 110 of a service provider may provide mobile device 101 with access to that is outside of an enterprise network. Access database 108 may provide access information about mobile device 101 or other devices connected within (or configured to be connected within) system 100. Access information may include 1) whether mobile device 101 is a laptop, tablet, Internet of Things (IoT) device, or mobile phone; 2) which enterprise of a plurality of enterprises mobile device has authorization to access; or 3) what occurs when device is connected to a particular access point or attempts access information at a particular location; among other things. In an example, location may be determined via global positioning system (GPS) or proximity to authorized user, which may forgo the need for a separate password. With regard to proximity to an authorized user, in an example, a second mobile device (not shown) that is within 5 feet of mobile device 101 may be indicated as an authorized device (switching from an unauthorized device) and therefore be able to access shared storage domain 107 or other systems of enterprise network 112 in which the second mobile device normally would not be able to access.

Enterprise network 112 may include user plane network elements 105, such as user plane MME (U-MME) 117, PCRF (not shown), SGW (not shown), U-PGW (not shown), or user plane SSD (U-SSD) 106, among other things. User plane network elements 105 may send user plane traffic to shared storage domain 107 or portal 109 (e.g., Internet, virtual machine, or virtual network function). U-SSD 106 may manage storage facilities residing in the customer premises or on the carrier network.

U-SSD 106 may be managed by C-SSD 104. C-SSD 104 may manage a group of U-SSDs 106 for one or more enterprises. C-SSD 104 may have an interface that enables it to be provisioned by customers. For example, an enterprise client may be able to provision the security and control of U-SSD 106 through C-SSD 104. C-SSD 104 may have or be connected with a security database (e.g., access database 108) that may include the profiles (e.g., device descriptions or access permissions) for use by C-SSD 104 or U-SSD 106. C-SSD 104 or U-SSD 106 may be implemented as virtual machines or virtual network functions.

FIG. 2 illustrates an exemplary message flow for a subscriber storage domain system. At step 130, device 101 may send a request for a communication session associated with a shared storage domain. For example, a computer aided design (CAD) application may be opened on mobile device 101 and a CAD file may be requested for editing or interactive viewing (e.g., zoom or change perspective) of vehicle parts. An agent may be imbedded on mobile device 101. The agent may incorporate information in the request that may indicate that the request is for data in shared storage domain 107 or shared storage domain 111. The agent may help manage the interactions between the operating system of mobile device 101 and the storage residing on mobile device 101. The agent may also control the interactions between the operating system and storage residing outside of the subscriber device (e.g., shared storage domain 107). When access to storage residing outside of the device (e.g., shared storage domain 107) is requested, the agent may direct the operating system of mobile device 101 to communicate with the appropriate SSD network element (e.g., C-SSD 104 or U-SSD 106).

At step 131, RAN 102 (e.g., a gNodeB or eNodeB) determines whether the request of step 130, should be sent to control plane elements 103 (e.g., C-MME 116 or C-SSD 104) or user plane elements 105 (e.g., U-MME 117 or U-SSD 106). In an example, if it is determined that this the initial communication session at a location for an application of mobile device 101, then C-MME 116 (a control plane element) may be sent the request of step 130 (at step 132). In another example, which is discussed in more detail herein, if it is determined that this is a subsequent request then RAN 102 may send the request of step 130 to U-MME 117 (a user plane element), which may be a route that has less latency.

At step 133, C-MME 116, for example, may determine, based on the request of step 132, that this is a request for a shared storage domain and therefore C-MME 116 may send the request to C-SSD 104 (step 134). At step 135, C-SSD may determine that the request of step 134 is a request for shared storage, for example an initial request or a request that has not occurred within an expiry time. Based on the request of step 134, at step 136, C-SSD 104 may request additional information associated with mobile device 101 to further indicate which shared storage domain to send the request of step 130 and to direct the communication session. The request for additional information may include an identifier of mobile device 101, an identifier of the application or file associated with request for storage at step 130, or the location of mobile device 101 (e.g., GPS coordinates, proximity to enterprise network 112, etc.), among other things. Based on the request for additional information of step 136, at step 137, access database 108 may determine additional information, such as information with regard to allowed access for storage (also referred to herein as access information), associated with mobile device 101 and provide at step 138 a response with the additional information (e.g., access information). The additional information received by C-SSD 104 at step 138 may include an indication of which shared storage domain or enterprise network that mobile device 101 is associated with (e.g., a first enterprise network shared storage domain, a second enterprise network shared storage domain, or a service provider shared storage domain), type of application, type of device (e.g., laptop, tablet, autonomous vehicle, or mobile phone), location of file to be transferred (e.g., transfer file from enterprise network 114 to enterprise network 112), or permissions (e.g., what occurs when mobile device is connected to a particular access point or attempts to access information while at a particular location). The requested file may not be within an enterprise network that meets the latency threshold for real-time storage and therefore C-SSD 104 (or other network element such as U-SSD 106) may instruct enterprise network 114 to transfer the file (for example) to enterprise network 112. Permissions may be based on time, location, date, identifier of mobile device 101, code (e.g., entered username or password), or the like. Permissions may include how much storage (e.g., MB) is allowed for the time, day, enterprise network, location, or the like.

With continued reference to FIG. 2, at step 139, based on the additional information or already obtained information, C-SSD 104 may determine that enterprise network 112 should receive communications associated with the request of step 130. It is contemplated that combination of information, such as location coordinates of mobile device 101 and type of mobile device 101 may determine the shared storage domains or permissions of mobile device 101. At step 140, C-SSD 104 may provide instructions to U-MME 117 or other network elements (e.g., RAN 102, control plane network elements 103, or user plane network elements 105) that communications associated with mobile device 101 (based on the access information for example) should be sent to enterprise network 112. For example, based on the instructions of step 140, subsequent communications may travel through link 122 in a more direct route to enterprise network 112 rather than through link 121 which connects with the control plane network elements 103. This more direct route may be further based on reaching one or more thresholds that may consider lower latency, less signaling, increased throughput, or the like thresholds. In addition, C-SSD 104 may forward the request of step 130.

At step 141, U-MME 117 may determine that the forwarded request of step 140 is indicative of a shared storage domain communication session that should be processed by U-SSD 106. U-SSD 106 may coordinate the shared storage domains 107 an provide the appropriate access. At step 142, U-MME 117 may inform RAN 102 or other network elements that communication requests from mobile device 101 (based on the access information) should be sent to enterprise network elements. For clarity, it is contemplated that this step 142 is similar to step 140 and may be completed in addition to or as an alternative to step 140, as is contemplated with other steps herein.

At step 143, U-MME 117 may forward the request of shared storage domain communication session (e.g., associated with step 130) to U-SSD 106. At step 144, U-SSD 106 may forward the request to shared storage domain 107. It is contemplated herein, that step 131-step 144 may be used to setup the initial communication path for the requested shared storage domain communication session of step 130. Steps in group 160 may be used for the back and forth data communication between enterprise network 112 and mobile device 101. Note that at step 145, RAN 102 (or other network elements) may send subsequent traffic (e.g., step 146) from mobile device 101 (which may based on the access information) to U-MME 117 or U-SSD 106, instead of control plane network elements 103. It is further contemplated that U-MME 117 (e.g., at step 150) may send traffic not only to U-SSD 106 and shared storage domain 107, but also (or alternatively) to portal 109, which may be the Internet, virtual network function, or the like.

For additional perspective, U-SSD 106 may reside on the customer premises and may provide multiple access to various services being requested and may be considered a MEC platform. It is contemplated herein that enterprise network 112 may be multi-access edge computing (MEC) that complements the corporate data center by providing compute, storage, networking and data analytics at locations closer to the data source (e.g. Internet of Things (IoT) devices, workers, operators, etc.) and points of consumption. The technology may be used with the infrastructure of 5G networks, particularly for handling the massive amounts of IoT devices (commercial and industrial) that are constantly connected to the network. The disclosed subject matter may allow for real-time access to storage. This may enable a large enterprise, for example, to provide local storage access transparently to subscribers without having to leave the enterprise premises or use additional mobile applications. For example, envision a large manufacturer that has access to a 5G network. Subscribers attaching to the 5G network (e.g., RAN 102) may be able to access in real-time U-SSD 106 (and shared storage domain 107) that may contain a large amount of storage. The devices (e.g., mobile device 101) may be able to access this storage transparently as if it was on the device.

Methods, systems, and apparatuses, among other things, as described herein may provide for means for managing or operating a subscriber storage domain. A method, system, computer readable storage medium, or apparatus has means for obtaining a first request, the first request comprising a storage request associated with a mobile device; based on the first request, sending a second request to an access database; and responsive to sending the second request, obtaining information associated with the mobile device, wherein the information comprises an indication of a shared storage domain for the mobile device. The method, system, computer readable storage medium, or apparatus has means for based on the information associated with the mobile device, sending routing information to one or more network elements for subsequent storage related requests for the mobile device. The method, system, computer readable storage medium, or apparatus has means for based on the information associated with the mobile device, determining a network element to forward subsequent storage related requests for the mobile device. The one or more network elements may include a radio access network device (e.g., base station), user plane network element, or control plane network element. The information may include permission information or type of device information. The storage related request may be based on a communication session associated with a first application. The routing information may be based on subsequent requests that include the same application or a threshold number of information (e.g., all or a majority percentage of information) that is the same as first request that was a storage related request. For example, with regard to majority of information, out of three individual pieces of information in a previous request, two pieces of information out of three match in the subsequent request (e.g., a first type of mobile device 101 and a first permission). All combinations in this paragraph (including the removal or addition of steps) are contemplated in a manner that is consistent with the other portions of the detailed description.

The term shared storage domain (e.g., subscriber storage domain) may refer to a set of storage which resides outside of the mobile device but seems that the storage is local to the device. In other words, the SSD may reside in the carrier's core network, in a user domain plain residing in the enterprise, or in a network cloud. In most instances, the storage appears local to the mobile device although it is a shared facility among subscribers.

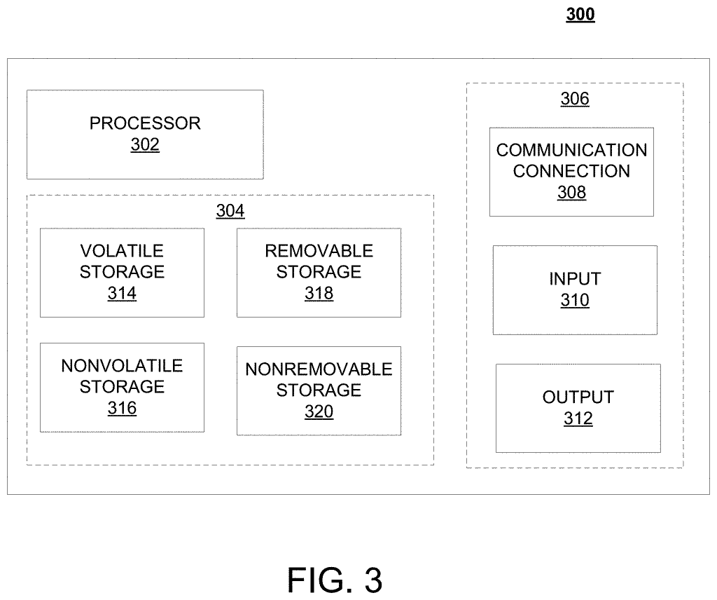

FIG. 3 is a block diagram of network device 300 that may be connected to or include a component of system 100 of FIG. 1. Network device 300 may include hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may include a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may include hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof In an example configuration, input/output system 306 may comprise a Wi-Fi finder, a two-way GPS chipset or equivalent, or the like, or a combination thereof

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

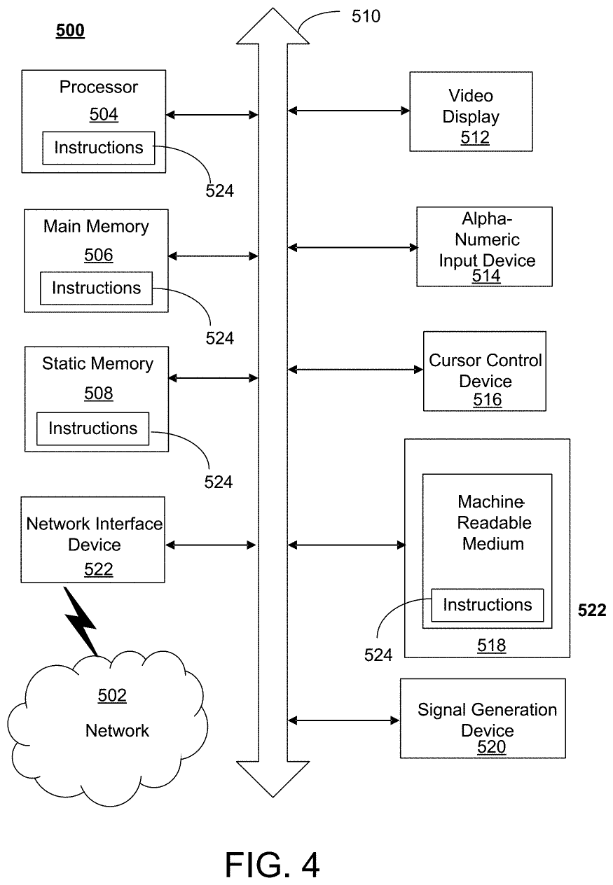

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, mobile device 101, user plane network element 103, control plane element 105, RAN 102, access database 108, and other devices of FIG. 1 and FIG. 2. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

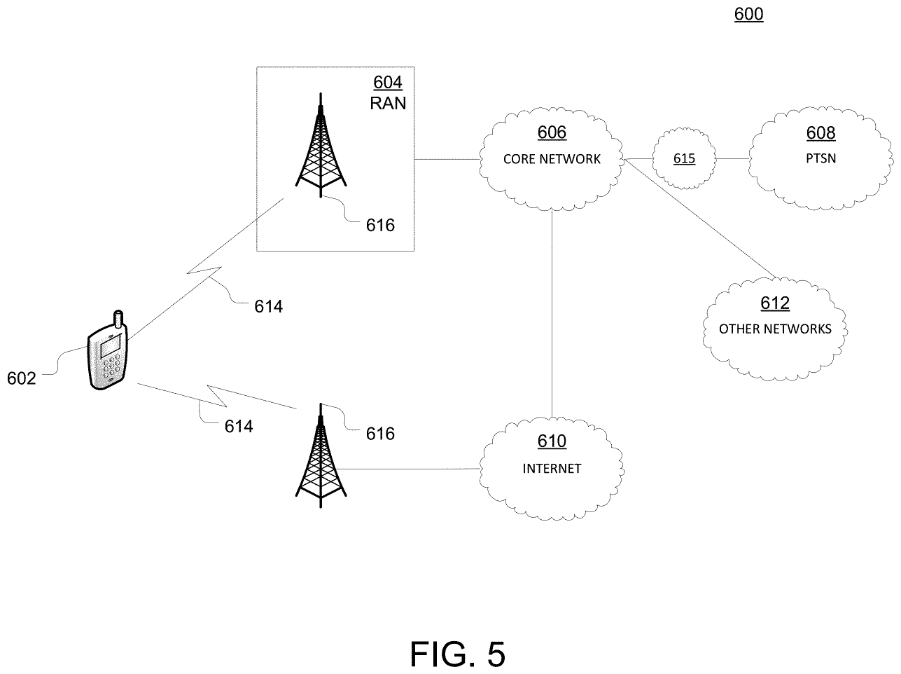

As shown in FIG. 5, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may include mobile device 101, network device 300, or the like, or any combination thereof By way of example, WTRUs 602 may be configured to transmit or receive wireless signals and may include a UE, a mobile station, a fixed or mobile subscriber unit, a pager, a cellular telephone, a PDA, a smartphone, a laptop, a netbook, a personal computer, a wireless sensor, consumer electronics, or the like. It is understood that the exemplary devices above may overlap in their functionality and the terms are not necessarily mutually exclusive. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNode B, a Home Node B, a Home eNode B, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (FISPA+). HSPA may include High-Speed Downlink Packet Access (I-ISDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 ix, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNode B, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, 5G (NR), etc.) to establish a picocell or femtocell. As shown in FIG. 5, base station 616 may have a direct connection to Internet 610. Thus, base station 616 may not be required to access Internet 610 via core network 606.

RAN 604 may be in communication with core network 606, which may be any type of network configured to provide voice, data, applications, and/or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 5, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 615 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. That is, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

As described herein, a telecommunications system wherein management and control utilizing a software defined network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which subscriber storage domain may be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure—subscriber storage domain—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope is defined by the claims, and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

1. An apparatus comprising:
a processor; and
a memory coupled with the processor, the memory comprising executable instructions that when executed by the processor cause the processor to effectuate operations comprising:
obtaining a first request, the first request comprising a storage request associated with a mobile device;
based on the first request, sending a second request to an access database;
responsive to sending the second request, obtaining information associated with the mobile device, wherein the information comprises an indication of a shared storage domain for the mobile device, and wherein the information comprises a permission based on location information; and
based on the information associated with the mobile device, sending routing information to a plurality of network elements for subsequent storage related requests for the mobile device.

2. The apparatus of claim 1, the operations further comprise based on the information associated with the mobile device and the routing information, determining a first network element of the plurality of network elements to forward subsequent storage related requests for the mobile device.

3. The apparatus of claim 1, wherein the plurality of network elements comprise a radio access network device.

4. The apparatus of claim 1, wherein the plurality of network elements comprise a user plane network element.

5. The apparatus of claim 1, wherein the plurality of network elements comprise a control plane network element.

6. The apparatus of claim 1, wherein the apparatus is a control plane network element.

7. The apparatus of claim 1, wherein location information is indicative of the proximity of an authorized mobile device to the mobile device.

8. A method comprises:
obtaining a first request, the first request comprising a storage request associated with a mobile device;
based on the first request, sending a second request to an access database;
responsive to sending the second request, obtaining information associated with the mobile device, wherein the information comprises an indication of a shared storage domain for the mobile device, and wherein the information comprises a permission based on location information; and
based on the information associated with the mobile device, sending routing information to plurality of network elements for subsequent storage related requests for the mobile device.

9. The method of claim 8, further comprises based on the information associated with the mobile device and the routing information, determining a first network element of the plurality of network elements to forward subsequent storage related requests for the mobile device.

10. The method of claim 8, wherein the plurality of network elements comprise a radio access network device.

11. The method of claim 8, wherein the plurality of network elements comprise a user plane network element.

12. The method of claim 8, wherein the plurality of network elements comprise a control plane network element.

13. The method of claim 8, wherein the plurality of network elements comprise a mobility management entity.

14. The method of claim 8, wherein the information comprises permission information that is based on the mobile device reaching a threshold distance from an authorized mobile device.

15. A computer-readable storage medium storing computer executable instructions that when executed by a computing device cause said computing device to effectuate operations comprising:
obtaining a first request, the first request comprising a storage request associated with a mobile device;
based on the first request, sending a second request to an access database;
responsive to sending the second request, obtaining information associated with the mobile device, wherein the information comprises an indication of a shared storage domain for the mobile device, and wherein the information comprises a permission based on location information; and
based on the information associated with the mobile device, sending routing information to plurality of network elements for subsequent storage related requests for the mobile device.

16. The computer-readable storage medium of claim 15, the operations further comprise based on the information associated with the mobile device and the routing information, determining a first network element of the plurality of network elements to forward subsequent storage related requests for the mobile device.

17. The computer-readable storage medium of claim 15, wherein the plurality of network elements comprise a radio access network device.

18. The computer-readable storage medium of claim 15, wherein the plurality of network elements comprise a user plane network element.

19. The computer-readable storage medium of claim 15, wherein the plurality of network elements comprise a control plane network element.

20. The computer-readable storage medium of claim 15, wherein the information comprises permission information that is based on the mobile device reaching a threshold distance from an authorized device.
